(19) United States
(12) Patent Application Publication
(10) Pub. No.: US 2012/0302219 A1
(43) Pub. Date: Nov. 29, 2012

(54) MONITORING AND AUTOMATING A NETWORK OF INDEPENDENT WIRELESS REMOTE DEVICES BASED ON A MOBILE DEVICE LOCATION

(76) Inventor: Vang VANG, St. Paul, MN (US)

(21) Appl. No.: 13/480,123

(22) Filed: May 24, 2012

Related U.S. Application Data
(60) Provisional application No. 61/489,327, filed on May 24, 2011.

(51) Int. Cl. H04W 4/02

(52) U.S. Cl. 455/414.1

(57) ABSTRACT

A wireless monitoring and automation network is provided that includes at least one mobile device and a plurality of independent wireless remote devices. Each of the plurality of independent wireless remote devices is configured to have its automated or monitored settings controlled based on the location of the mobile device, and/or user settings, and/or time, and/or environmental conditions. Each independent wireless remote device can communicate directly to the at least one mobile device and thus not dependent on supporting electronic devices or cabling hardware to control the automated or monitored settings.

### PRIORITY

This application claims the benefit of U.S. Provisional Application No. 61/489327, entitled “MONITORING AND AUTOMATING A NETWORK OF INDEPENDENT WIRELESS REMOTE DEVICES BASED ON A MOBILE DEVICE LOCATION”, filed May 24, 2011, and which is incorporated herein by reference in its entirety.

### FIELD

This disclosure relates to the field of monitoring and automating wireless remote devices. More particularly, this description relates to monitoring and automating a network of independent wireless remote devices based on a mobile device location, and/or the wireless remote devices' programmed settings.

### BACKGROUND

Conventionally, without user intervention and a line of sight, wireless remote devices can only self-configure based on configured time settings, Also, monitoring of wireless remote devices typically involve a user initiated process. Currently, conventional wireless remote devices each have their own unique wireless protocol in which to communicate. Further conventional wireless remote devices each require their own wireless remote controller to configure the wireless remote devices, leading to numerous wireless remote controllers for controlling multiple wireless remote devices. Today, systems where one wireless remote controller is capable of controlling multiple remote devices are dependent on a fixed centralized main controller device that is linked wired or wirelessly to all the wireless remote devices. Also, systems which utilize location based automation require location tracking devices which are separate from the wireless remote device of intended operation. These systems currently depend on supporting devices aside from the wireless remote devices, additional cabling, and an aggressive installation process, making monitoring and automation of a network of wireless remote devices expensive and difficult to install and modify, and not easily portable.

### SUMMARY

The embodiments provided herein are to a monitored and automated network of independent wireless remote devices. In particular, the embodiments described herein provide a wireless automation network that includes at least one mobile device and a plurality of independent wireless remote devices. Each of the plurality of independent wireless remote devices can be configured to have its settings based on the location of the mobile device, user settings, time conditions, or ambient environmental conditions.

The embodiments described herein provide a wireless monitored and automated network in which each of the plurality of independent wireless remote devices and/or mobile devices are able to determine the distance between the particular independent wireless remote device and the mobile device. Based on this distance, the independent wireless remote device settings can be set either by the independent wireless remote device itself or the mobile device. In the case where the wireless remote device is a wireless remote monitoring device, an alert from the independent wireless remote device can be sent to the mobile device. In some embodiments, the particular independent wireless remote device or mobile device determines its distance from each other based on the wireless signal strength. In other embodiments, the mobile device determines its distance from a particular independent wireless remote device(s) based on Global Positioning Network (GPS) coordinates of the mobile device and the particular independent wireless remote device(s).

In one embodiment, a monitoring and automating system is provided. The system includes a mobile device and one or more independent wireless remote devices. Each of the one or more independent wireless remote devices includes a central processing unit, a target device unit, a memory unit and a wireless transceiver unit configured to communicate with the mobile device. The central processing unit of each of the one or more independent wireless remote devices is configured to use data received from the wireless transceiver unit and data stored in the memory unit to control the target device unit. Also, the central processing unit is configured to control operation of the target device unit based on a distance between the mobile device and the independent wireless remote device.

In another embodiment, an independent wireless remote device is provided. The independent wireless remote device includes a central processing unit, a target device unit, a memory unit and a wireless transceiver unit. The target device unit and the memory unit are each connected to the central processing unit. The wireless transceiver unit is also connected to the central processing unit and configured to communicate with a mobile device. The central processing unit is configured to use data received from the wireless transceiver unit and data stored in the memory unit to control operation of the target device unit. Also, the central processing unit is configured to control the target device unit based on a distance between the independent wireless remote device and the mobile device.

In yet another embodiment, a method for operating an independent wireless remote device within a monitoring and automating system is provided. The independent wireless remote device is integrated with a central processing unit, a wireless transceiver unit and a target device unit. The method includes determining a distance between the independent wireless remote device and a mobile device based on a signal strength between the wireless transceiver unit of the independent wireless remote device and the mobile device using a first wireless protocol signal. The method also includes controlling, via the central processing unit, operation of the target device unit based on the distance settings or user settings when the distance between the independent wireless remote device and the mobile device is less than or equal to a first distance. Further, the method includes controlling, via the central processing unit, operation of the target device unit based on time settings and/or environmental settings when the distance between the independent wireless remote device and the mobile device is greater than the first distance.

In some embodiments, the distance within which the central processing unit operates the target device unit is configurable by the user. The distance can be configured to be greater than or less than the wireless communication protocol range.

In some embodiments, each of the plurality of independent wireless remote devices includes a control mechanism such as, for example, a motor, a relay, an infrared module or a wireless interface that is adjusted or controlled directly by the mobile device.

In some embodiments, at least one of the plurality of independent wireless remote devices is configured to acquire telemetry data and sends this telemetry data directly to the mobile device. The mobile device is then able to directly control the particular independent wireless remote device based on the telemetry data.

In some embodiments, at least one of the plurality of independent wireless remote devices is configured adjust its settings based on time and/or environmental conditions when the distance between the particular independent wireless remote device and the mobile device cannot be determined.

In some embodiments, at least one of the plurality of independent wireless remote devices is configured to control at least one secondary device. In some embodiments, the particular independent wireless remote device is configured to convert a first wireless signal type to a second wireless signal type.

In some embodiments, at least one of the plurality of independent wireless remote devices is controlled by a plurality of mobile devices, In some embodiments, the particular independent wireless remote device(s) distinguishes the plurality of mobile devices based on a unique ID associated with each mobile device.

In some embodiments, at least one of the plurality of independent wireless remote devices is powered via at least one of a standard 110 VAC outlet, a portable battery, or a solar power cell.

In some embodiments, at least one of the plurality of independent wireless remote devices includes a switch for enabling and disabling wireless control via the mobile device.

In some embodiments, at least one of the plurality of independent wireless remote devices is controlled via a light switch as if it is a wired device. Also, in some embodiments the light switch enables the independent wireless remote device for wireless automation using a light switching sequence (e.g., a sequence of switch turn on time and turn off time, decoded by the independent wireless remote device and used to determine the mode of operation of the independent wireless remote device mode of operation).

In some embodiments, the mobile device is configured to use a GPS and/or a local wireless protocol interchangeably in order to determine its location relative to the location of an independent wireless remote device. The location of the independent wireless remote device is determined by the mobile device based on the GPS. In some embodiments, the mobile device is configured to use a GPS and a local wireless protocol periodically in order to reduce the amount of power consumed by the mobile device. Also, in some embodiments, the mobile device allows a user to manually force the mobile device to use the GPS and/or the local wireless protocol to update the location of the mobile device and the independent wireless remote device.

In some embodiments, a wireless network for monitoring and automating a network of independent wireless remote devices with one or more mobile devices is provided, where automation and monitoring are based on a distance between the mobile device and one or more of the independent wireless remote devices.

In some embodiments, monitoring of the independent wireless remote device can be based on, for example, (a) a distance between the mobile device and one or more of the independent wireless remote devices; (b) time of day settings; (c) environmental settings such as, for example, ambient lighting, humidity, temperature, etc.; (d) user settings or actions set via the mobile device; and (e) user settings set via one or more of the independent wireless remote devices.

In some embodiments, automation of one or more of the independent wireless remote devices can be based on, for example, (a) a distance between the mobile device and one or more of the independent wireless remote devices; (b) time of day settings; (c) environmental settings such as, for example, ambient lighting, humidity, temperature, etc.; (d) user settings or actions set via the mobile device; and (e) user settings set via one or more of the independent wireless remote devices. The mobile device or the independent wireless remote device can determine the distance between the mobile device and the independent wireless remote device.

In some embodiments, the mobile device can interchangeably use multiple methods to determine the distance between the mobile device and the independent wireless remote device to minimize power consumption. These methods can utilize bidirectional and unidirectional wireless protocols such as, for example, WiFi, Bluetooth, ZigBee, and Global Positioning System (GPS) protocols, etc.

In some embodiments, the independent wireless remote device can interchangeably use multiple methods to determine the distance between the mobile device and the independent wireless remote device to minimize power consumption. The independent wireless remote device methods can utilize bidirectional wireless protocols such as, for example, WiFi, Bluetooth, ZigBee, and Global Positioning System (GPS) protocols, etc.

In some embodiments, the independent wireless remote device can be an independent intermediate automation device to an end product, or can be integrated into the end product.

In some embodiments, the independent wireless remote device can be an independent intermediate automation device used to automate an end product (secondary device) such as, for example, (a) a wireless module integrated with a motor; (b) a wireless module integrated with a relay; (c) a wireless module integrated with a power strip; (d) a wireless module integrated with another backend wireless module of a different wireless protocol; (e) a wireless module integrated with a wired backend communication protocol.

In some embodiments, the independent wireless remote device can be an independent intermediate monitoring device used to monitor an end product (secondary device) such as, for example, a wireless module integrated with one or more of the following sensors: (a) a temperature sensor; (b) a humidity sensor; (c) a fire/smoke detection sensor; (d) a water sensor; or (e) a motion sensor; etc.

In some embodiments, the independent wireless remote device can be an independent automation end product such as, for example, (a) a wireless module integrated with a light bulb; (b) a wireless module integrated with a set of window blinds or shades; (c) a wireless module integrated with a media device such as, for example, a TV, a DVD player, a media center, speakers, etc.; (d) a wireless module integrated with an appliance such as, for example, a microwave, an oven, a stove, a coffee maker, a dishwasher, a washer, a dryer, etc.; (e) a wireless module integrated with a security system such as, for example, an automotive security system or a home security system, where the security system may include one or more of a camera, alarm, electronic door latches, motion sensors, etc.

In some embodiments, the independent wireless remote device can be an independent monitoring end product such as, for example, (a) a sensory product including one or more sensors such as, for example, a temperature sensor, a humidity sensor, a fire detection sensor, a water sensor, a motion sensor, etc.; (b) a wireless module integrated with a media device, such as a TV, a DVD player, a media center, speakers, etc.; (c) a wireless module integrated with an appliance such as, for example, a microwave, an oven, a stove, a coffee maker, a dishwasher, a washer, a dryer, etc.; (d) a wireless module integrated with an appliance such as, for example, a microwave, an oven, a stove, a coffee maker, a dishwasher, a washer, a dryer, etc.; (e) a wireless module integrated with a security system such as, for example, an automotive security system or a home security system, where the security system may include one or more of a camera, an alarm, an electronic door latch, etc.

In some embodiments, the independent wireless remote device can be an independent monitoring end product or an intermediate device configured such that the end product or end device can provide the mobile device with data or notifications.

In some embodiments, the independent wireless remote device may contain one or more unique automation and monitoring settings for one or more mobile devices.

In some embodiments, one or more of the independent wireless remote devices within the wireless network can distinguish between one or more mobile devices based on a unique identification number, code, tag, etc.

In some embodiments, the independent wireless remote device can be powered from an external 110 VAC outlet, an integrated battery, an integrated solar cell, etc.

In some embodiments, the independent wireless remote device may include an integrated automation switch to enable and disable wireless automation controls. Disabling the wireless automation controls can be configured to allow only wired or direct control of the independent wireless remote device.

In some embodiments, one or more of the independent wireless remote devices may not include an integrated automation switch to enable and disable wireless automation controls. In these embodiments, an external light switch or power switch can be used to enable and disable the wireless automation controls.

In some embodiments, one or more of the independent wireless remote devices may not, include an integrated automation switch to enable and disable wireless automation controls. In these embodiments, an external light switching sequence or a power switching sequence can enable or disable the wireless automation controls.

In one embodiment, a monitoring and automating system is provided. The system includes a mobile device, and one or more independent wireless remote devices. The mobile device includes a GPS component, a wireless communication component configured to communicate with the one or more independent wireless remote devices, and a control component configured to send control instructions to one of the one or more independent wireless remote devices. The control component is also configured to calculate a distance between one of the one or more independent wireless remote devices and the mobile device. The GPS component is configured to determine a location of one of the one or more independent wireless remote devices. The wireless communication component and the GPS component are each configured to determine a distance between the mobile device and one of the one or more independent wireless remote devices. The control component is also configured to store settings of each of the one or more independent wireless remote devices. Each of the one or more independent wireless remote devices includes a central processing unit, a target device unit, a memory unit, and a wireless transceiver unit to communicate with the mobile device. The central processing unit is configured to use data received from the wireless transceiver unit and data stored in the memory unit to control the target device unit. The central processing unit is also configured to control operation of the target device unit based on the distance between the mobile device and the wireless remote device. Also, the central processing unit is configured to control operation of the target device unit based on user settings, time settings, and/or ambient environmental settings, etc. The central processing unit can interchangeably use the mobile device to wireless remote device distance, user settings, time settings, and/or ambient environment settings to control the target device unit. The target device unit may or may not be integrated into the independent wireless remote device. The target device unit is not limited to just one target device, and one or more target device units may also provide data to the central processing unit for controlling one or more other target device units.

Also, the independent wireless remote devices and/or the mobile device can configured to calculate a distance between the mobile device and the independent wireless remote device based on a signal strength between the mobile device and the independent wireless remote device using a single wireless protocol, multiple wireless protocols, or a combination of wireless protocols and Global Positioning System (GPS) coordinates.

Further, the independent wireless remote device and/or the mobile device can be configured to interchangeably use a wireless protocol signal strength and Global Positioning System coordinates to calculate a distance between the mobile device and the independent wireless remote device.

Moreover, the independent wireless remote device can be at least one of an intermediate automation device, an intermediate monitoring device, an end product with automation capability, and an end product with monitoring capability.

Also, the intermediate automation device can be one of a motor, a relay, a power strip, a light bulb adapter configured to house a light bulb, a wireless bridge, or any intermediate device used to automate an end product not capable of wireless automation.

Further, the intermediate monitoring device can be one of a temperature sensor, a humidity sensor, a fire/smoke sensor, a water sensor, an image sensor, a motion sensor, or any intermediate device used to monitor an end product not capable of wireless monitoring.

Moreover, the end product can have automation capability and can be one of a set of blinds or shades (e.g., any type of home and commercial furnishing), a media device (e.g., any type of fixed and portable media device), and an appliance (e.g., any type of commercial and industrial appliance).

Also, the end product can have monitoring capability and can be one of a home and auto surveillance system (e.g., any type of security system), a fire alarm (e.g., any type of residential and industrial hazard detection system).

Further, the central processing unit of the independent wireless remote device can be configured to control operation of the target device unit based on: a real-time user instruction received from the mobile device when the mobile device is within a wireless protocol range of the independent wireless remote device; a configured user instruction based on a mobile device to independent wireless remote device distance, a unique user mobile ID, time settings, and/or ambient environmental settings (e.g., time of day, lighting condition, temperature conditions, humidity conditions, and etc.), when the mobile device is within the wireless protocol range of the wireless remote device; a configured user instruction based on user settings, time settings, and/or ambient environmental settings, when the mobile device is outside of the wireless protocol range of the independent wireless remote device.

In another embodiment, an independent wireless remote device is provided. The independent wireless remote device includes a central processing unit, one or more target device units connected directly or indirectly to the central processing unit, a memory unit connected to the central processing unit, and a wireless transceiver unit connected to the central processing unit to communicate with a mobile device. The central processing unit is configured to use data received from the mobile device via the wireless transceiver unit and data stored in the memory unit to control operation of the target device unit. Also, the central processing unit is configured to control operation of the target device unit based on a distance between the independent wireless remote device and the mobile device. The central processing unit is also configured to control operation of the target device unit based on user settings, time settings, and/or ambient environmental settings. Further, the central processing unit can interchangeably use the mobile device to wireless remote device distance, user settings, time settings, and/or ambient environment settings to control the one or more target device units. The target device unit may or may not be integrated into the independent wireless remote device. The one or more target device units may not be limited to just one target device. Further one or more target device units may also provide data to the central processing unit for controlling one or more other target device units.

Also, the central processing unit can be configured to calculate the distance between the wireless transceiver unit and a mobile device based on, the wireless protocol signal strength between the wireless transceiver unit and the mobile device.

Further, the wireless protocol signal can be one of a WiFi signal, a Bluetooth signal, a ZigBee signal or any other bidirectional wireless protocol.

Moreover, the one or more target device units can be at least one of an intermediate automation device, an intermediate monitoring device, an end product with automation capability, and an end product with monitoring capability.

Also, the intermediate automation device can be one of a motor, a relay, a power strip, a light bulb adapter configured to house a light bulb, a wireless bridge, or any intermediate device used to automated an end product not capable of wireless automation.

Further, the intermediate monitoring device can be one of a temperature sensor, humidity sensor, a fire/smoke sensor, a water sensor, image sensor, a motion sensor, or any intermediate device used to monitor an end product not capable of wireless monitoring.

Moreover, the end product can have automation capability and can be one of a set of blinds or shades (e.g., any type of home and commercial furnishings), a media device (e.g., any type of fixed and portable media device), and an appliance (e.g., any type of commercial and industrial appliance).

Also, the end product can have monitoring capability and can be one of a home and auto surveillance system (e.g., any type of security system), a fire alarm (e.g., any type of residential and industrial hazard detection system).

Further, the independent wireless remote device can include an integrated or external (e.g., light switch) automation switch unit configured to instruct the central processing unit to control operation of the target device unit based on a distance between the wireless transceiver unit and the mobile device when the automation switch unit is enabled, and configured to instruct the central processing unit to not control operation of the target device unit based a distance between the wireless transceiver unit and the mobile device when the automation switch unit is disabled.

Moreover, the external automation switch can include a power switch and a switching sequence that enables and disables the central processing unit to control the operations of the target device unit based on the distance between the mobile device and the wireless remote device.

In yet another embodiment, a method for operating an independent wireless remote device within a monitoring and automating system is provided. The wireless remote device includes a central processing unit, a wireless transceiver unit and a target device unit. The method includes determining a distance between the wireless remote device and a mobile device based on a signal strength between the wireless transceiver unit and the mobile device using a wireless protocol signal. The method also includes controlling, via the central processing unit, operation of the target device unit based on distance settings, time settings, environmental settings, or use settings when the distance between the remote device and the mobile device is within range of the wireless protocol. Further, the method includes controlling, via the central processing unit, operation of the target device unit based on user settings, time settings or environment settings when the distance between the remote device and the mobile device is greater than the range of the wireless protocol.

In another embodiment, a mobile device is provided. The mobile device includes a GPS component, a wireless communication component configured to communicate with one or more independent wireless remote devices, a control unit configured to control and configure one of the one or more independent wireless remote devices. The control unit is also configured to calculate a distance between the mobile device and one of the one or more independent wireless remote devices. The GPS component is configured to determine a location of one of the one or more independent wireless remote devices. The wireless communication component and the GPS component are each configured to determine a distance between the mobile device and one of the one or more independent wireless remote devices. The control component is also configured to store settings of each of the one or more independent wireless remote devices.

An advantage of the embodiments provided herein is that each of the plurality of independent wireless remote devices are directly controlled by the at least one mobile device and not via a wired or wireless centralized main controller between the at least one mobile device and the plurality of independent wireless remote device. Another advantage of the embodiments provided herein is that the wireless automation network is portable and not limited to a fixed location or installation setup.

### BRIEF DESCRIPTION OF THE DRAWINGS

FIG. 1 illustrates a monitored and automated wireless network or system according to one embodiment.

FIG. 2 illustrates a block diagram of an independent wireless remote device according to one embodiment.

FIGS. 3A and 3B illustrates a flow chart of a process for operating a plurality of independent wireless remote devices within a monitored and automated wireless network, according to one embodiment.

FIG. 4 illustrates a flow chart of a process for operating a mobile device within the monitored and automated wireless network, according to one embodiment.

FIG. 5A illustrates a circuit diagram of an independent wireless remote device for controlling a target device unit, where the independent wireless remote device is powered and automation of the independent wireless remote device and the target device is enabled/disabled by a fixed power switch that is not part of the independent wireless remote device, according to one embodiment.

FIG. 5B illustrates a flow chart of a process for enabling/disabling automation of the independent wireless remote device and the target device of FIG. 5A, according to one embodiment.

FIG. 6A illustrates a circuit diagram of an independent wireless remote device for controlling a target device, where the independent wireless remote device is connected to a power outlet and automation of the independent wireless remote device and the target device is enabled/disabled by a power switch of the independent wireless remote device, according to one embodiment.

FIG. 6B illustrates a flow chart of a process for enabling/disabling automation of the independent wireless remote device and the target device of FIG. 6A is, according to one embodiment.

FIG. 7A illustrates a circuit diagram of an independent wireless remote device for controlling a target device, where the independent wireless remote device receives power from an internal regenerative power source and automation of the independent wireless remote device and the target device is enabled/disabled by a power switch of the independent wireless remote device, according to one embodiment.

FIG. 7B illustrates a flowchart of a process for enabling/disabling automation of the independent wireless remote device and the target device of FIG. 7A, according to one embodiment.

FIG. 8 illustrates a timing chart for enabling/disabling automation of the independent wireless remote device shown in FIG. 5 using a power switch that is also used for powering the independent wireless remote device, according to one embodiment.

### DETAILED DESCRIPTION

The embodiments provided herein are to monitoring and automating a network of independent wireless remote devices. In particular, the embodiments described herein provide a wireless automation network that includes at least one mobile device and a plurality of independent wireless remote devices. Each of the plurality of independent wireless remote devices is configured to configure its settings based on the location of the mobile device or the independent wireless remote device's configured settings (e.g., user settings, time settings, environmental conditions, etc.).

The embodiments described herein provide a wireless automation network in which each of the plurality of independent wireless remote devices and/or mobile devices are configured to determine the distance between the particular independent wireless remote device and the mobile device. Based on this distance the independent wireless remote device can be configured to reconfigure its settings. In some embodiments, the particular independent wireless remote device and/or mobile device determines its distance based on the wireless signal strength between the particular independent wireless remote device and the mobile device and based on this distance is configured to configure the independent wireless remote device settings, or alert the mobile device in the case of an independent wireless remote monitoring device. In other embodiments, the mobile device determines its distance from a particular independent wireless remote device(s) based on Global Positioning Network (GPS) coordinates of the mobile device and the particular independent wireless remote device(s). In yet some other embodiments, the mobile device is configured to transition from using GPS coordinates for determining its distance from an independent wireless remote device(s), to using the wireless signal strength to determine its distance from the independent wireless remote device(s).

For example, in one embodiment when a mobile device moves within range of an independent wireless remote device attached to a light source, the mobile device will transition, for example, from GPS to Bluetooth for determining a distance between the mobile device and the wireless remote device(s). When the mobile device is within a Bluetooth range and within a user defined range, the light source will be turned on based on settings configured by a user. In another example, in one embodiment when a mobile device moves within a certain distance of an independent wireless remote device connected to a car security system, the independent wireless remote device will determine that the mobile device has the appropriate unique ID with permissions and is within range, and will unlock the doors and turn on the lights of the car based on a settings provided by a user.

In some embodiments, each of the plurality of independent wireless remote devices includes a control mechanism such as, for example, a motor, a relay, an infrared module that is adjusted or controlled directly by the mobile device, etc. In these embodiments, an independent wireless remote device, that is connected to a target device or houses a target device, is configured to adjust the settings of the target device based on programmable settings set by a user. Examples of possible target devices include, but are not limited to, light sources (e.g. turning the light source on or off and dimming the light source), window blinds/shades (e.g. adjusting the angle and retraction amount of the blinds/shades), a wireless power strip (e.g. turning on or off each socket/channel independently, or setting each socket/channel voltage and/or current limit).

In some embodiments, at least one of the plurality of independent wireless remote devices is configured to acquire telemetry data and sends this telemetry, data directly to the mobile device. The mobile device is then able to directly control the particular independent wireless remote device based on the telemetry data when, for example, the mobile device is within range of the independent wireless remote device range. When the mobile device is out of range, the independent wireless remote device can configure the target device based on the telemetry data and the settings stored in the independent wireless remote device. In these embodiments, an independent wireless remote device is connected to or integrated with a sensor (e.g., a temperature sensor, a smoke detector, a motion sensor, an image sensor, an ambient sensor, etc.) and sends data or alerts to the mobile device when the sensor detects an abnormal reading. For example, in some embodiments an independent wireless remote device is a smoke detector and is configured to alert a mobile device when smoke is detected in the area being monitored by the smoke detector.

In some embodiments, at least one of the plurality of independent wireless remote devices is configured to change its settings based on time and/or environmental conditions when the distance between the particular independent wireless remote device and the mobile device cannot be determined. For example, in one embodiment, the independent wireless remote device is connected to window blinds that self-adjust to low light conditions at a certain time of day when the mobile device is out of range.

In some embodiments, at least one of the plurality of independent wireless remote devices is configured to control at least one secondary device. In some embodiments, the particular independent wireless remote device is configured to convert a first wireless signal type to a second wireless signal type. For example, in one embodiment, the independent wireless remote device controls a television and other infrared remote media devices with a Bluetooth enabled mobile device. In other examples, the independent wireless remote device is configured to transfer data from one wireless protocol to another wireless protocol. For example, from a Bluetooth protocol to an infrared protocol, a Bluetooth protocol to a Wi-Fi protocol, a Bluetooth protocol to a ZigBee protocol, etc.

In some embodiments, at least one of the plurality of independent wireless remote devices is controlled by a plurality of mobile devices. In some embodiments, the particular independent wireless remote device(s) distinguishes the plurality of mobile devices based on a unique ID associated with each mobile device. For example, an independent wireless remote device distinguishes the plurality of mobile devices based on the mobile device's phone number, Bluetooth universally unique identifier (UUID), etc.

In some embodiments, at least one of the plurality of independent wireless remote devices is powered via at least one of a standard 110 VAC outlet, a portable battery, or a solar power cell.

In some embodiments, at least one of the plurality of independent wireless remote devices includes a switch for enabling/disabling wireless control and automation via the mobile device.

In some embodiments, at least one of the plurality of independent wireless remote devices is controlled via a light switch as if it is a wired device. Also, in some embodiments the light switch powers and enables/disables the independent wireless remote device for wireless control and automation using a light switching sequence (e.g., a sequence of power on and power off decoded by the independent wireless remote device).

In some embodiments, the mobile device is configured to use a GPS and/or a wireless protocol interchangeably in order to determine the distance between the independent wireless remote device and the mobile device. When the mobile device is out of range of the wireless protocol (e.g., Bluetooth, Wi-Fi, ZigBee, etc.), the distance between the independent wireless remote device and the mobile device is determined by the GPS coordinates of the independent wireless remote device and the real time mobile device coordinates. In some embodiments, the mobile device is configured to use a GPS and a wireless protocol periodically in order to reduce the amount of power consumed by the mobile device. Also, in some embodiments, the mobile device allows a user to log the independent wireless remote device's GPS coordinates and use the coordinates to calculate the mobile device to independent wireless remote device distance.

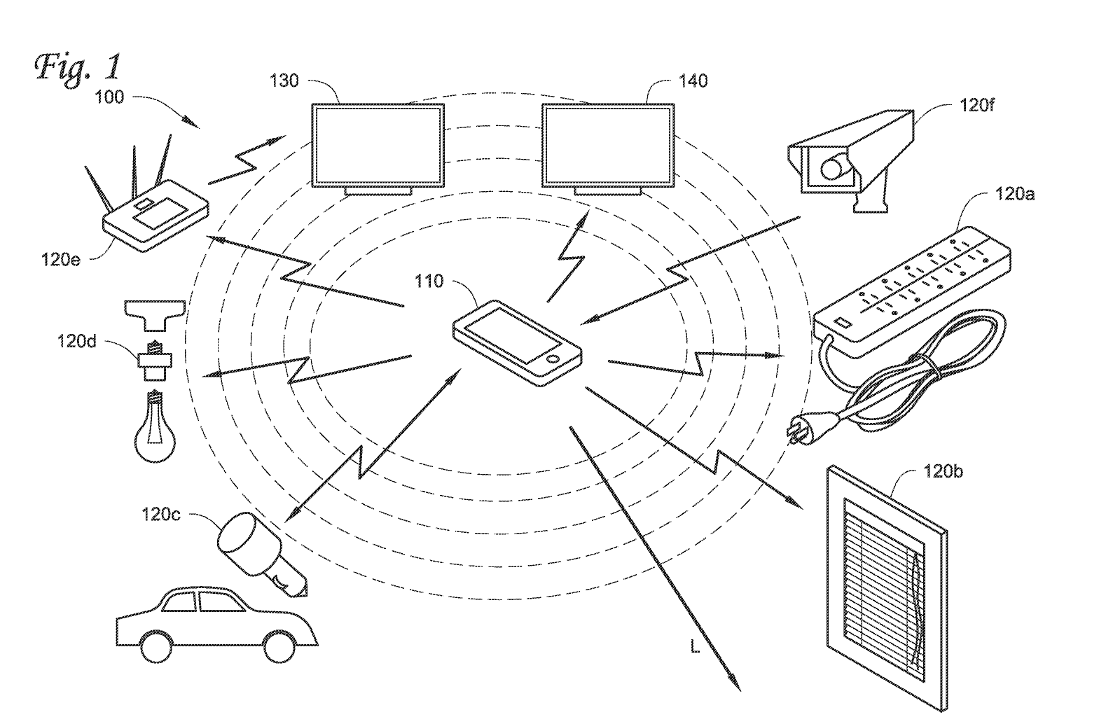

FIG. 1 illustrates a monitored and automated wireless network or system 100 according to one embodiment. The system 100 includes a mobile device 110 and a plurality of independent wireless remote devices 120a-f, an incompatible wireless device 130 and a compatible wireless device 140 of the same type. While the embodiment in FIG. 1 only provides a single mobile device 110, in other embodiments the system 100 can include a plurality of wireless mobile devices. Also, the number of independent wireless remote devices 120a-f incompatible wireless devices 130 and compatible wireless devices 140 in the system 100 can vary based on the needs of the user.

The mobile device 110 is a smart phone and is configured to receive and transmit data using a plurality of wireless communication protocols. In particular, the mobile device 110 is configured to receive and transmit data within a cellular phone data network, such as, for example AT&T, Sprint, T-Mobile, etc. data networks. Also, the mobile device 110 has GPS capability and wireless protocol capabilities such as, for example, Bluetooth and Wi-Fi capabilities. In some embodiments, the mobile device 110 is not limited to the above listed wireless communication protocols, but can also be configured to receive and transmit data using one or more of the above listed wireless communication protocols and/or, one or more other local wireless communication protocols including, for example, Infrared (IR) and ZigBee. In other embodiments, the mobile device 110 is not limited to a smart phone and can be any other type of portable device with wireless communication capabilities such as for example, a laptop, tablet PC, iPad, iPod, watch, smart identification card/key, etc.

The plurality of independent wireless remote devices 120a-f are a plurality of devices whose settings are controlled based on a distance L between the particular independent wireless remote device 120 and the mobile device 110, user defined settings when the mobile device 110 is within a wireless protocol range or out of the wireless protocol range (e.g., loss of communication between the mobile device 110 and a particular independent wireless remote device 120a-f), and/or user-initiated commands, and/or time settings, and/or ambient environmental settings. As shown in FIG. 1, the independent wireless remote devices 120a-f, the incompatible wireless remote device 130 and the compatible wireless remote device 140 can be a variety of electrical and/or electro-mechanical devices. The system 100 is not limited to the particular independent wireless remote devices 120a-f, the incompatible wireless remote device 130 and the compatible wireless remote device 140 provided in FIG. 1 and is merely provided for illustrative purposes. In other embodiments, other types of independent wireless remote devices, incompatible wireless remote devices and compatible wireless remote devices may be used within the system 100. Each of the independent wireless remote devices 120a-f, the incompatible wireless remote device 130 and the compatible wireless remote device 140 are described below.

The independent wireless remote device 120a is a wireless power strip. In one embodiment, the independent wireless remote device 120a is powered directly from a wall outlet, The system 100 allows the mobile device 110 location and or user-initiated commands to wirelessly control each outlet socket/channel on the independent wireless remote device 120a to be on or off, The independent wireless remote device 120a also has current limiting and voltage settings that are controllable by the location of the mobile device 110 and/or user-initiated commands via the mobile device 110. When the mobile device 110 is determined to be out of range from the independent wireless remote device 120a (e.g., there is a loss of communication or the mobile device 110 is outside a wireless protocol range of the wireless protocol being used, the independent wireless remote device 120a is configured to set its outlet channel, current limiting, and voltage settings based on user defined settings set by the mobile device 110 and/or based on sensed ambient environmental conditions (e.g., time settings, temperature conditions, lighting conditions, motion conditions, etc.).

The independent wireless remote device 120b is a set of wireless blinds or shades. In one embodiment, the independent wireless remote device 120b is powered directly from a wall outlet and/or by a regenerative power source, such as solar power, a rechargeable battery, etc. The system 100 allows the mobile device 110 location and/or user-initiated commands to wirelessly control the blinder angle and retraction amount on the independent wireless remote device 120b. When the mobile device 110 location is determined to be out of range from the independent wireless remote device 120b, the independent wireless remote device 120b will set its blinder angle and retraction amount based on user defined settings set by the mobile device 110, and/or based on sensed ambient environmental conditions (e.g., time settings, temperature conditions, lighting conditions, motion conditions, etc.).

The independent wireless remote device 120c is a part of wireless car security system. In one embodiment, the independent wireless remote device 120c is powered directly from a car power outlet but can be separate from the car electronics. The system 100 allows the mobile device 110 location and or user-initiated commands to wirelessly control the car's trunk lid, doors, lighting, temperature, alarm, radio station, and etc. by using the independent wireless remote device 120c as a wireless bridge to the car's wired/wireless security and entertainment systems. In another embodiment, the independent wireless remote device 120c is integrated into the car electronics. When the independent wireless remote device 120c is integrated into the car electronics, the mobile device 110 location and or user-initiated commands can directly control the car's trunk lid, doors, lighting, temperature, alarm, and etc. When the mobile device 110 is determined to be out of range from the independent wireless remote device 120c (e.g., there is a loss of communication or the mobile device 110 is outside a wireless protocol range), the independent wireless remote device 120c is configured to set the car's lighting, temperature, alarm, doors, and etc., based on user defined settings set by the mobile device 110, and/or based sensed ambient environmental conditions (e.g., time settings, temperature conditions, lighting conditions, motion conditions, etc.).

The independent wireless remote device 120d is a wireless light bulb adapter housing a light bulb. In one embodiment, the independent wireless remote device 120d is powered via a light bulb socket. The system 100 allows the mobile device 110 location and or user-initiated commands to wirelessly control the light bulb on and off, and level of dimming using the independent wireless remote device 120d. When the mobile device 110 is determined to be out of range from the independent wireless remote device 120d (e.g., there is a loss of communication or the mobile device 110 is outside a wireless protocol range of the wireless protocol), the independent wireless remote device 120d is configured to set the light bulb lighting condition based on user defined settings set by the mobile device 110, and or based on the sensed ambient environmental conditions (e.g., time settings, temperature conditions, lighting conditions, motion conditions, etc.). In some embodiments, the independent wireless remote device 120d is a wireless lamp that is powered via a wall outlet.

The independent wireless remote device 120e is a wireless to wireless bridge unit. In one embodiment, the independent wireless remote device 120e is powered directly from a wall outlet and/or by a regenerative power source, such as solar power, a rechargeable battery, etc. The system 100 allows the mobile device 110 location and or user-initiated commands to wirelessly control settings of an incompatible wireless device 130 (channel, volume, color settings, auxiliary inputs, and etc.) through the independent wireless remote device 120e. In this embodiment, the incompatible wireless remote device 130 is a television that does not have compatible wireless hardware to communicate with mobile device 110, but has wireless hardware to communicate with the independent wireless remote device 120e. When the mobile device 110 is determined to be out of range from the independent wireless remote device 120e (e.g., there is a loss of communication or the mobile device 110 is outside a wireless protocol range), the independent wireless remote device 120e is configured to set the channel, volume, color settings, auxiliary inputs, and etc., of the incompatible wireless device 130 based on user defined settings set by the mobile device 110, and or based on the sensed ambient environmental conditions (e.g., time settings, temperature conditions, lighting conditions, motion conditions, etc). In other embodiments, the independent wireless remote device 120e can be configured to wirelessly control other incompatible wireless remote devices 130 such as, for example, a receiver, a game system, a CD/DVD/Blue Ray player, kitchen appliance, etc.

The independent wireless remote device 120f is a wireless camera. In one embodiment, the independent wireless remote device 120f is powered directly from a wall outlet. The system 100 allows the independent wireless remote device 120f to send notifications, images, video streams, or other monitored data to the mobile device 110 in the event of breached security or hazard detection. The mobile device 110 can also control a camera orientation when within a wireless protocol range of the independent wireless remote device. When the mobile device 110 is determined to be out of range from the independent wireless remote device 120f (e.g., there is a loss of communication or the mobile device 110 is outside the range of the wireless protocol), the independent wireless remote device 120f is configured to set the camera orientation based on stored programmed settings set by the mobile device 110, and or based on the sensed ambient environmental conditions (e.g., time settings, temperature conditions, lighting conditions, motion conditions, etc).

The compatible wireless device 140 can be any consumer media device, security system, environment control system, kitchen appliance, and etc., that has compatible wireless hardware to communicate with mobile device 110. The system 100 allows the mobile device 110 location and or user-initiated commands to wirelessly control the compatible wireless device 140. When the mobile device 110 location is determined to be in communication range of the compatible wireless device 140 (e.g. within a wireless protocol range), the mobile device 110 is configured to automatically control the compatible wireless device 140 based on user defined settings set by the mobile device 110. When the mobile device 110 is determined to be out of range from the compatible wireless device 140 (e.g., there is a loss of communication or the mobile device 110 is outside the wireless protocol range), the mobile device 110 is configured to no longer be able to control the compatible wireless device 140.

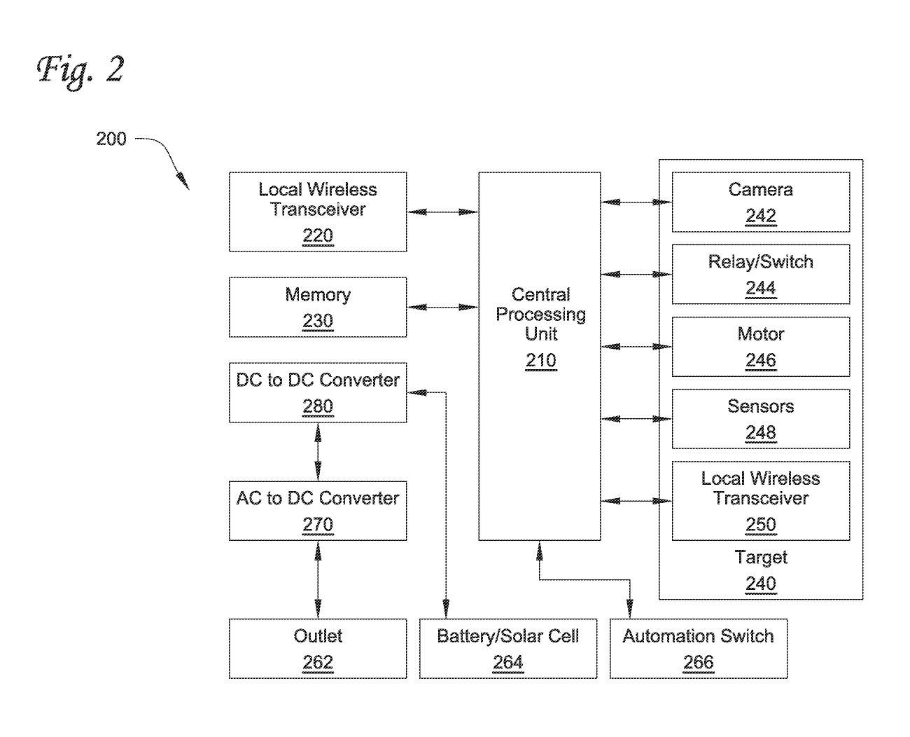

FIG. 2 illustrates a block diagram of an independent wireless remote device 200 according to one embodiment. The independent wireless remote device 200 includes a central processing unit (CPU) 210 coupled to a primary wireless transceiver unit 220, a memory unit 230 and a target device unit 240. The primary wireless transceiver unit 220 allows the independent wireless remote device 200 to communicate with a mobile device within a wireless automation network or system (as shown in FIG. 1). The CPU 210 uses data received from the primary wireless transceiver 220 and data stored in the memory unit 230 to create control signals for controlling the target device component 240. The independent wireless remote device 200 also includes an AC to DC converter unit 270 and a DC to DC converter unit 280.

The target device unit 240 includes, but is not limited to, a camera component 242, a relay/switch component 244, a motor component 246, one or more sensing components 248, and a secondary wireless transceiver component 250. The target device unit 240 may or may not be housed and/or integrated within the independent wireless remote device 200.

The camera component 242 provides, for example, automotive video surveillance functionality when the independent wireless remote device 200 is, for example, a car security system, or home video surveillance functionality when the independent wireless remote device 200 is, for example, a home security system. The relay/switch component 244 provides, for example, power functionality when the independent wireless remote device 200 is, for example, a power switch and/or automated light functionality when the independent wireless remote device 200 is, for example, a light bulb adapter. The motor component 246 provides, for example, automated window blinds/shades functionality when the independent wireless remote device 200 is, for example, a set of blinds or shades, or automated door opening and closing functionality when the independent wireless remote device 200 is, for example, a garage door opener. The one or more sensing components 248 provides, for example, ambient sensor functionality when the independent wireless remote device 200 is, for example, a light bulb adapter, or temperature sensor functionality when the independent wireless remote device 200 is, for example, a thermostat. The secondary wireless transceiver component 250 transmits, for example, television or media electronics control signals to provide television or media electronics control functionality when the independent wireless remote device 200 is a television or media electronics remote bridge, or keyless entry control signals when the independent wireless remote device 200 is an automotive keyless entry bridge unit. The secondary wireless transceiver component 250 can transmit control signals using one or more of a plurality of wireless communication protocols including, for example, Bluetooth, Wi-Fi, Infrared, ZigBee, etc.

The independent wireless remote device 200 is powered via at least one of a power outlet unit 262 or a regenerative power source unit 264 (e.g. solar power cell, rechargeable battery, etc.). As shown in FIG. 2, when the independent wireless remote device 200 receives power via the power outlet unit 262, power first enters the AC to DC converter unit 270 and then the DC to DC converter unit 280. When the independent wireless remote device 200 receives power via the regenerative power source 264, power enters the independent wireless remote device 200 via the DC to DC converter 280.

The independent wireless remote device 200 also includes an automation switch unit 266 that enables or disables an automation feature within the independent wireless remote device 200. When the independent wireless remote device 200 has the automation switch unit 266 enabled, the functionality of the independent wireless remote device 200 is controlled by the location and inputs from a mobile device (such as mobile device 110 shown in FIG. 1). When the remote independent wireless device 200 has the automation switch unit 266 disabled, the functionality of the independent wireless remote device 200 is no longer controlled based on the location of the mobile device or settings inputted via the mobile device.

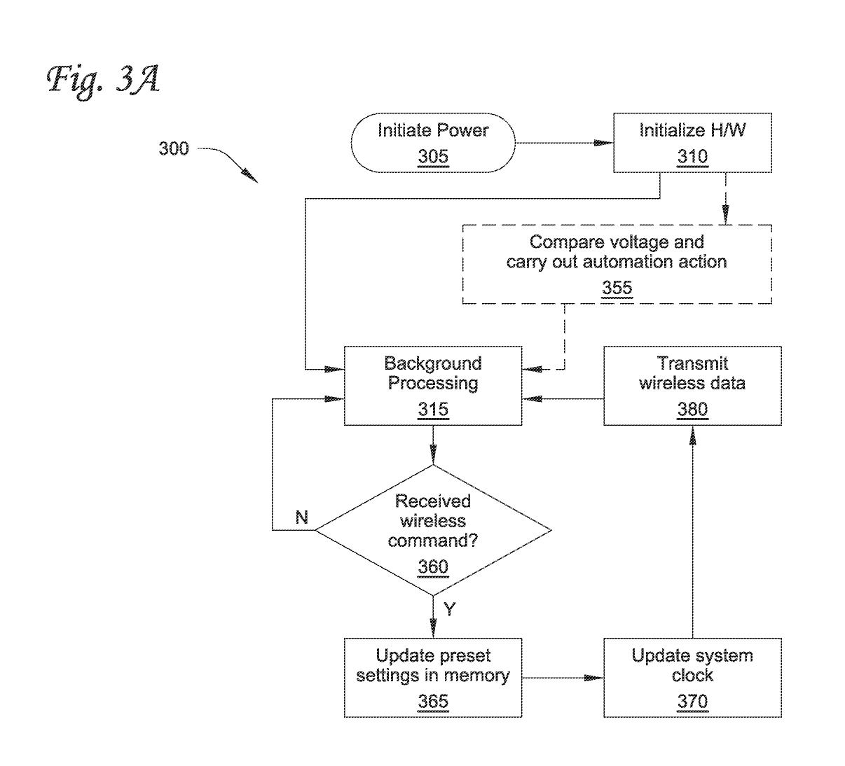

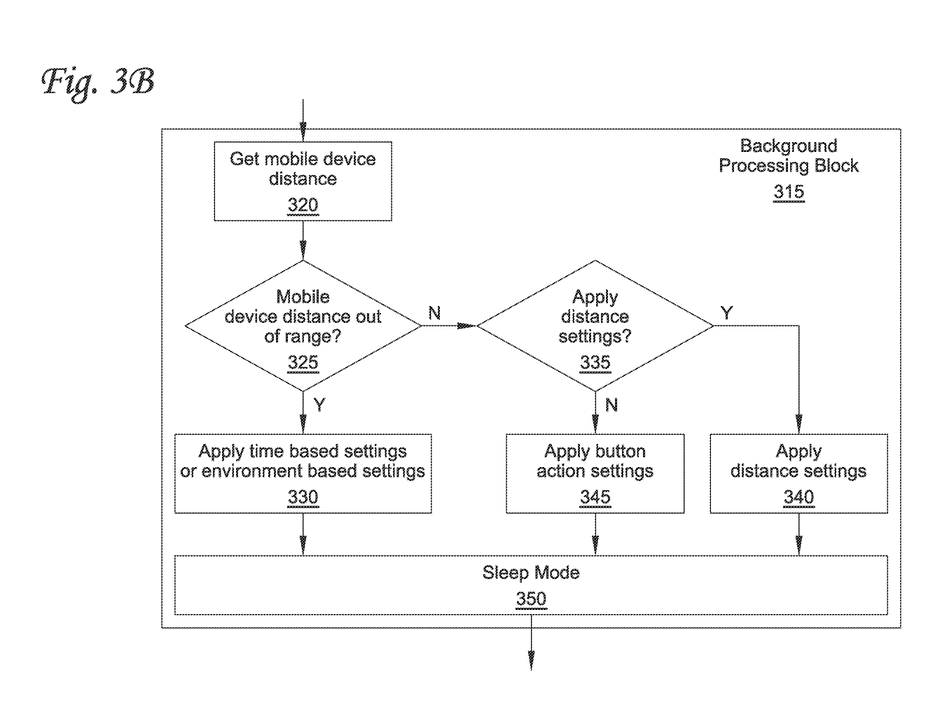

FIGS. 3A and 3B provide one embodiment of a process 300 operating a plurality of independent wireless remote devices (such as independent wireless remote devices 120a-f shown in FIG. 1) within a wireless automation network (such as system 100 shown in FIG. 1). The process 300 begins at 305 where power is initiated in the independent wireless remote device(s). The process 300 then proceeds to 310, whereby the independent wireless remote device(s) initializes the hardware of the remote device(s). At 310, initialization of the independent wireless remote device(s) includes but is not limited to: setting up software drivers for hardware; presetting global software variables and memories; etc.

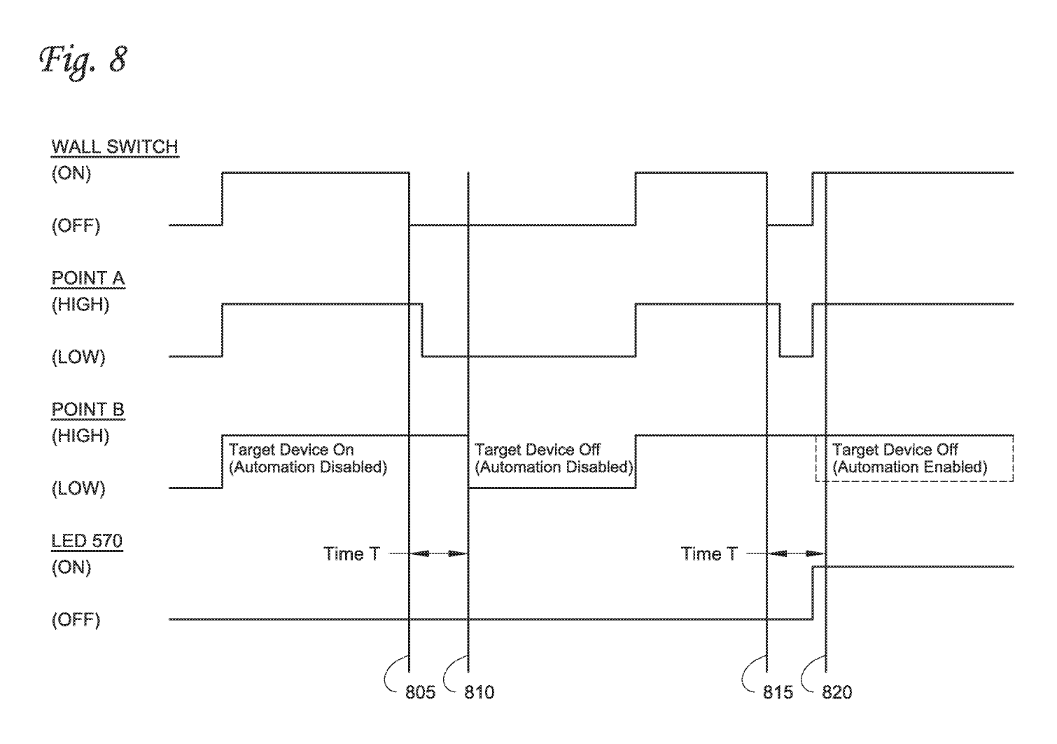

In some embodiments, when the independent wireless remote device(s) is powered by a wall switch, the process 300 then proceeds to 355. At 355, the independent wireless remote device(s) detects whether automation is enabled or disabled using a wall switch (such as the wall switch 510, DC voltage converters 555 and 557, and points A and B in the sequence shown in FIG. 8). The process 300 then proceeds to 315. In some embodiments where the independent wireless remote device(s) is not powered by a wall switch, the process 300 proceeds directly to 315 after 310.

At 315, background processing is performed. As shown in FIG. 3B, background processing begins at 320, whereby the independent wireless remote device(s) gets the distance between the independent wireless remote device(s) and a mobile device. The distance can either be calculated by the mobile device and transmitted to the independent wireless remote device(s), or can be calculated by the independent wireless remote device(s) alone. In this embodiment, the distance is determined by evaluating the wireless signal strength between the mobile device and the independent wireless remote device(s).

At 325, a CPU (such as CPU 210 shown in FIG. 2) of the independent wireless remote device(s) determines whether the mobile device is considered out of range based on the distance determined at 320. The mobile device is considered out of range when the distance between the mobile device and the independent wireless remote device(s) is greater than the wireless communication protocol range. In some embodiments the wireless communication protocol range can be, for example, between ˜10 to ˜100 meters. If the independent wireless remote device(s) determines that the mobile device is out of range, the process 300 proceeds to 330. If the independent wireless remote device(s) determines that the mobile device is not out of range, the process 300 proceeds to 335.

At 330, the independent wireless remote device(s) applies preprogrammed settings such as time based or environment based settings from a memory unit (such as memory unit 230 shown in FIG. 2). In time-based settings, the independent wireless remote device(s) along with the targeted device will be controlled by time. For example, a light will turn on when the time is later than 6 pm and the mobile device is out of range. An example of environment based settings is, for example, turning on a light when the outdoor lighting condition is below a lumen. The process 300 then proceeds to 350.

At 335, the CPU of the independent wireless remote device(s) determines whether to apply distance settings. If so, the CPU applies the distance settings by generating and sending distance based control signals to a target device unit (such as target device unit 250 shown in FIG. 2) at 340 before proceeding to 350. For example, if there are no time-based settings to turn on a light bulb, the independent wireless remote device will automatically turn on the light bulb when the mobile device moves within range of the independent wireless remote device(s).

If the CPU of the independent wireless remote device(s) determines not to apply distance settings, the process 300 proceeds to 345. At 345, the independent wireless remote device(s) ignores all preset settings and applies button action commands sent from the mobile device and then proceeds to 350.

At 350, the independent wireless remote device(s) enters a sleep mode and waits a preset amount of time or until an interrupt occurs (e.g., a wireless command signal is sent to the independent wireless remote device from the mobile device 110). Otherwise, the process 300 then proceeds to 360.

At 360, the independent wireless remote device(s) determines whether a wireless command signal from the mobile device has been received. If so, the process 300 proceeds to 365. If not, the process 300 proceeds back to 315.

At 365, the CPU of the independent wireless remote device(s) updates preset settings stored in the memory unit and then proceeds to 370. Preset input settings can include, for example, a mobile device to independent wireless remote device(s) distance, lighting thresholds, temperature thresholds, pressure thresholds, time, motion tracking parameters, etc. Preset output settings include, for example, a linear motor position, a rotational motor position, a target temperature, target lighting, a power switch state (e.g., “on”, “off”, etc.), a lock position (e.g., “on”, “off”, etc.), etc. When the independent wireless remote device(s) is a wireless bridge, a sequence of secondary wireless commands may be the preset output settings. At 370, the independent wireless remote device(s) updates its internal system clock to ensure that the independent wireless remote device(s) and the mobile device clock are properly synced. The process 300 then proceeds to 380.

At 380, the independent wireless remote device(s) transmits wireless data to the mobile device. The wireless data transmitted to the mobile device includes, for example, preset settings, communication handshaking data such as acknowledge, sensed telemetry data, independent wireless remote device(s) health status, debug data, etc. The transmitted wireless data can be requested by the mobile device or can be part of the communication response protocol. The process 300 then proceeds back to 315 for background processing.

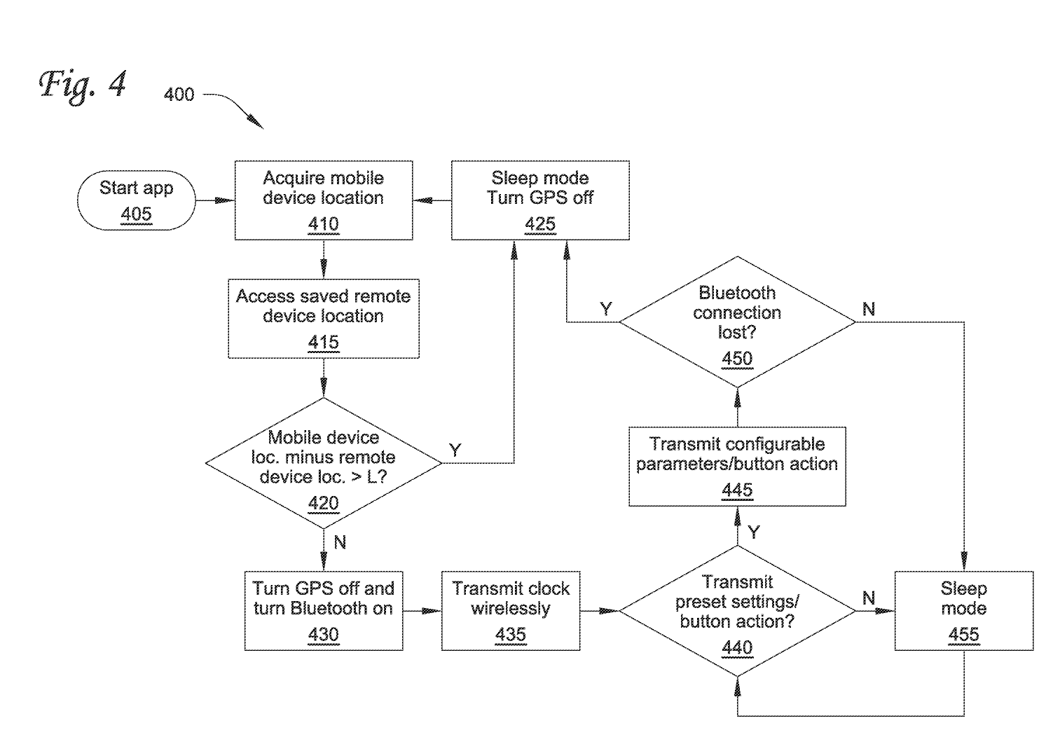

FIG. 4 illustrates a flow chart of a process 400 for operating a mobile device (such as the mobile device 110 shown in FIG. 1) within a wireless automation network (such as the network 100 shown in FIG. 1), according to one embodiment. In this embodiment, the mobile device uses GPS and a local area wireless protocol to automate and wirelessly control a plurality of independent wireless remote devices (such as the plurality of independent wireless remote devices 120 shown in FIG. 1). Also, in this embodiment the GPS and local area wireless protocols are used intermittently to reduce power consumption.

In this embodiment, the mobile device uses GPS and a local area wireless protocol to monitor and automate a plurality of independent wireless remote devices wirelessly. Also, in this embodiment the GPS and local area wireless protocols are used interchangeably and intermittently to reduce power consumption.

The process 400 begins at 405. At 410, the mobile device determines its location. In some embodiments, the mobile device determines its location using a GPS component of the mobile device. The process 400 then proceeds to 415. At 415, the mobile device retrieves a saved location of the independent wireless remote device(s). In order for 415 to be valid, a predefined location (e.g., coordinates) for the independent wireless remote device(s) must be set. Setting the coordinates of the independent wireless remote device(s) may be performed upon a first and new connection of the mobile device to the independent wireless remote device(s), or as requested by the mobile device user using GPS.

At 420, the mobile device calculates the distance between the mobile device and the particular independent wireless remote device(s) using GPS coordinates. If the distance is greater than a predefined distance L, the process 400 proceeds to 425. In some embodiments, the distance L is less than or equal to a wireless protocol range of the wireless protocol being used. For example, if the wireless protocol being used is Bluetooth, the distance L can be, for example, ˜10 meters. If the distance is less than the predefined distance L, the process 400 proceeds to 430. The distance L can be defined by the user to be any distance within the wireless protocol range of the independent wireless remote device(s).

At 425, the GPS component of the mobile device enters a sleep mode, which turns the GPS component off for a set amount of time. The period of time that the GPS component is turned off can be configured by the user. After the predetermined period of time has passed, the process 400 proceeds back to 410.

At 430, the mobile device turns off the GPS component and turns on a local wireless protocol component that uses a local wireless protocol such as, for example, Bluetooth, Wi-Fi, ZigBee, etc, of the mobile device when the mobile device is within the local wireless protocol range. For example, if the wireless protocol being used is Bluetooth, the distance L can be, for example, ˜10 meters. The process 400 then proceeds to 435.

At 435, the mobile device transmits a clock signal wirelessly to at least one of the plurality of independent wireless remote devices and ensures that the mobile device and independent wireless remote device(s) are synced in time. The process 400 then proceeds to 440.

At 440, the mobile device determines whether to transmit predefined settings (e.g., independent wireless remote device(s) settings when the mobile device is out of range, such as lighting thresholds in the case of a light source, level of security in the case of a home or auto security system, power switch state in the case of a power strip, etc.) button action commands (mobile application buttons to command independent wireless remote device(s), for example; dimming lights, turning on television, enabling auto security system, raising blinds, etc.) to at least one of the plurality of independent wireless remote devices. If so, the process 400 proceeds to 445. If not, the process 400 proceeds to 455.

At 445, the mobile device transmits the predefined settings or the button action commands to at least one of the plurality of independent wireless remote devices. The process 400 then proceeds to 450.

At 450, the mobile device determines if a local wireless protocol connection between the mobile device and at least one of the plurality of independent wireless remote devices is lost. If so, the process proceeds back to 425. If not, the process proceeds to 455.

At 455, the local wireless protocol component of the mobile device enters a sleep mode which turns the local wireless protocol component off for a predefined amount of time or until an interrupt occurs (e.g., a user alters the predefined settings for the independent wireless remote device or provides button action commands using the mobile device), which causes the process 400 to proceed back to 440. The amount of time that the mobile device is in the sleep mode can be configured by the user. For example, in some embodiments, the user can define the amount of time until the mobile device enters the sleep mode to ˜5 minutes.

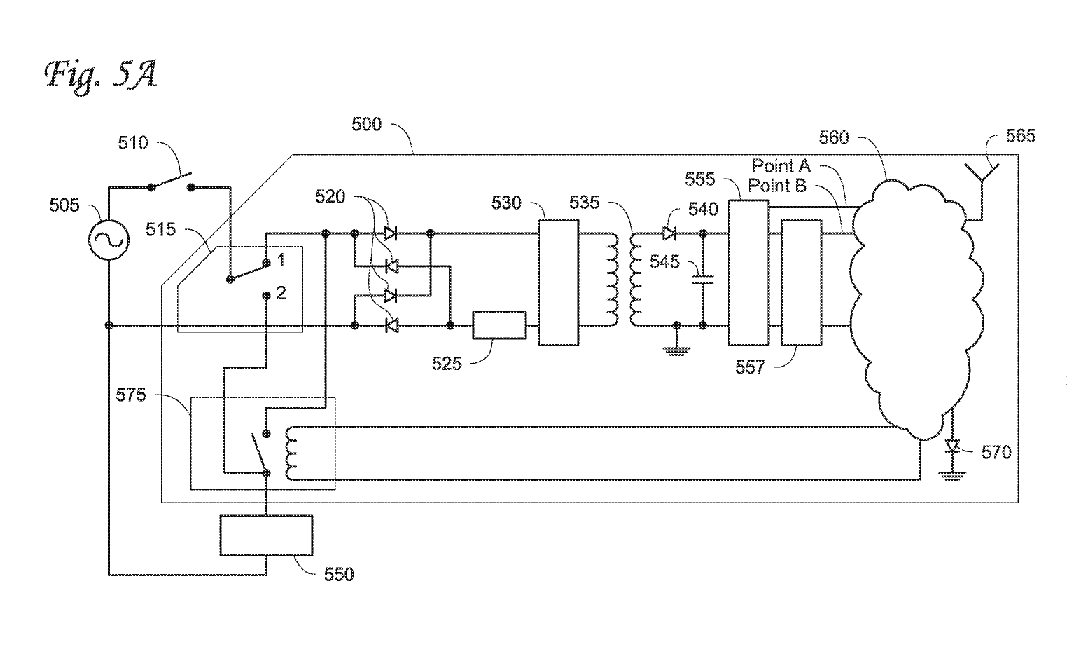

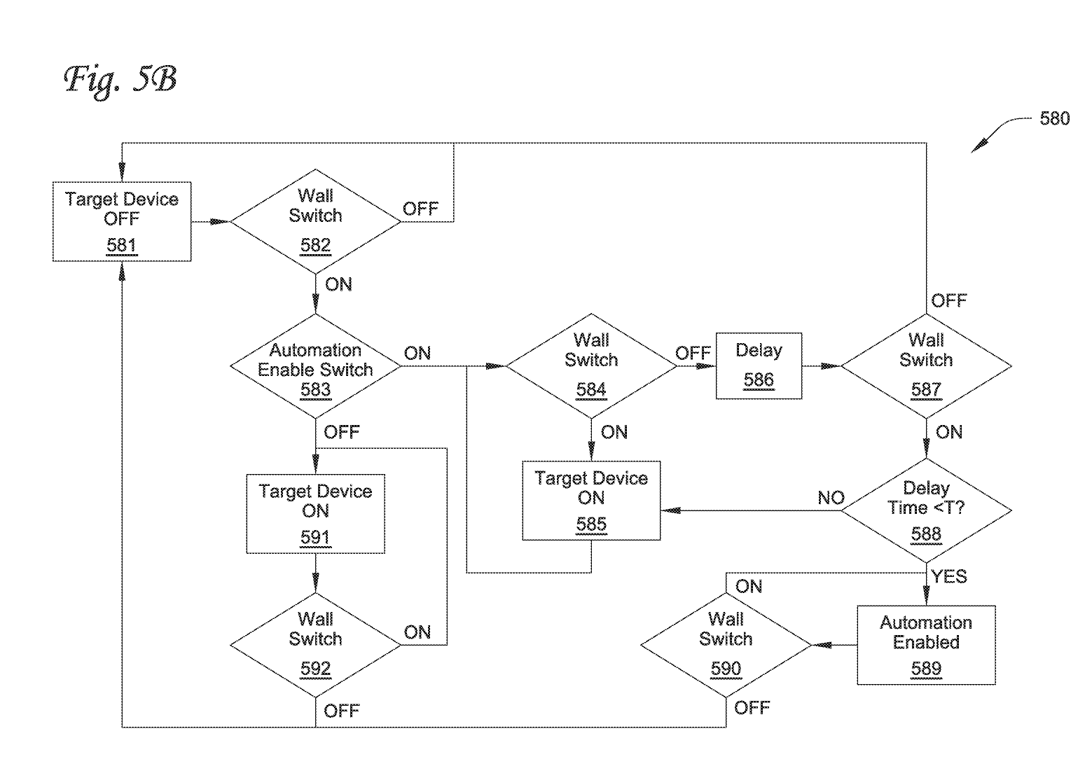

FIG. 5A illustrates a circuit diagram of an independent wireless remote device 500 for controlling a target device 550, where the independent wireless remote device 500 is powered by a power switch (e.g. wall switch) 510, and automation of the independent wireless remote device 500 and the target device 550 is enabled by an automation switch 515 and a sequence of on and off settings by the wall switch 510. The independent wireless remote device 500 receives power from a power source 505 via the power switch (e.g. wall switch) 510. The embodiment in FIG. 5 also allows the independent wireless remote device 500 and the target device 550 to be disabled from an automation wireless network (such as the automation wireless network 100 shown in FIG. 1) via either the power switch 510 or the automation switch 515. That is, the independent wireless remote device 500 and the target device 550 are disabled when the automation switch 515 is set to position 2. When the automation switch 515 is in position 1, turning off the wall switch 515 for a time greater than time T (see timing 805 and timing 810 shown in FIG. 8), disables automation of the independent wireless remote device 500 and the target device 550. In some embodiments, the time T can be in a range of ˜milliseconds to ˜seconds. When the automation switch 515 is set o position 1, sequencing the wall switch 510 from on-off-on settings in less than time T (see timing 815 and timing 820 in FIG. 8), enables the independent wireless remote device 500 along with the target device 550 for automation. In this embodiment, the power source 505 is an AC power source and connected to wall switch 510.

While the target device 550 is external to the independent wireless remote device 500, in other embodiments, the target device 550 is integrated within the independent wireless remote device 500. In this embodiment, the independent wireless remote device 500 is configured to be plugged into a light bulb socket or a wall power outlet and is controlled by a wired power switch such as a wall switch.

The independent wireless remote device 500 also includes a set of diodes 520 connected to a pulse width modulation circuit (PWM) 525 and a filter/transient protection circuit 530. The PWM 525 is also connected to the filter/transient protection circuit 530. The filter/transient protection circuit 530 is connected to a transformer 535. The transformer 535 is connected to a diode 540. The diode 540 is connected to a capacitor 545 and a first DC power supply and sequencing circuit 555. The first DC power supply and sequencing circuit 555 is connected to a second DC power supply and sequencing circuit 557 and an analog/digital sense processor circuit 560. The second DC power supply and sequencing circuit 557 is also connected to the analog/digital sense processor circuit 560. The analog/digital sense processor circuit 560 is connected to an antenna 565 and to an LED 570. In this embodiment, the target device 550 is driven by an AC power signal, and thus the independent wireless remote device 500 also includes a relay switch 575. In some embodiments, when the target device 550 is driven by a DC power signal, the independent wireless remote device 500 does not include a relay switch. In these embodiments, the target device 550 is driven by a DC power signal via the first or second DC power supply and sequencing circuits 555, 557 or the analog/digital sense processor circuit 560.

Also, in some embodiments the relay switch 575 and relay control signal sent by the switch 575 is not limited to an actual relay, but can be any type of control signal/device that provides the appropriate signal to power and/or control the target device 550. The rectifier diodes 520, the pulse width modulator 525, the transformer 535, the reverse current protection diode 540, and the bulk capacitor 545, are provided for converting an AC voltage into a DC voltage. The filter and transient protection circuit 530 is provided to prevent over voltage or over current transients from damaging the independent wireless remote device 500. The LED 570 is provided to indicate whether automation is enabled or disabled.

When the automation switch 515 is set to position 2, the position of the wall switch 510 determines whether the target device 550 is able to receive power or not. When the automation switch 515 is set to position 1 and the power switch 510 is closed, the first DC power supply and sequencing circuit 555 and the second DC power supply and sequencing circuit 557 output voltages at Point A and Point B. Voltages at point A and point B remain high as long as the power switch 510 remains closed. When the voltages at point A and point B are high, the analog/digital sense processor circuit 560 determines that the target device 550 should be on, and power is supplied to the target device 550 via the relay switch 575. When the power switch 510 is opened, all electronic circuits within the independent wireless remote device 500 are turned off and no power is supplied to the target device 550.

When the automation switch 515 is set to position 1 and the power switch 510 has been closed (e.g. the on setting) for a period of time S and then the power switch 510 is quickly opened (e.g. the “off” setting) and then closed (e.g. the on setting) for a time less than or equal to T, the voltage at point A is interrupted but the voltage at point B remains steady. The time S can be the amount of time point B reaches a defined voltage and is able to sustain the defined voltage for a duration of time T. The time T is the duration point B can maintain its voltage when the wall switch 510 is opened (e.g. the “off” setting). In some embodiments, the time T can be in a range of ˜milliseconds to ˜seconds. The analog/digital sense processor circuit 560 detects the interruption at point A and transitions to have the target device 550 controlled remotely using a wireless mobile controller. Once the target device 550 is set to communicate wirelessly, the analog/digital sense processor circuit 560 sends a signal to turn on the LED 570 and configure relay switch 575 per wireless commands or settings.

As shown in FIG. 8, just prior to time 805, automation via an automation wireless network is disabled (indicated by the low voltage for the LED 570) even though the power switch 510 (indicated by the high voltage for the wall switch) and the automation switch 515 (indicated by the high voltage for point A and point B) are both on. At time 805, the power switch 510 is turned off and shortly thereafter the voltage at point A goes low while the voltage at point B remains high. After the predetermined time period T passes at time 810, the voltage at point B also goes to low. Sequencing conditions of the power switch 510 between the time 805 and the time 810 treat the target device 550 as if it is connected directly to the outlet via power switch 510.

In contrast, between the time 815 and the time 820, the power switch 510 is quickly turned off and then on within the time period T. As soon as the power switch 510 is turned on again, the voltage at point A goes high and the LED 570 is turned on indicating that automation via an automation wireless network is enabled.

FIG. 5B illustrates a process 580 fore enabling/disabling automation of the independent wireless remote device 500 and the target device 550 (shown in FIG. 5A), The process 580 begins at 581 where the target device 550 is “OFF”. The process 580 then proceeds to 582.

At 582, the process 580 determines whether the wall switch 510 is “ON” or “OFF”. If the wall switch 510 is “ON”, the process 580 proceeds to 583. If the wall switch 510 is “OFF”, the process 580 returns to 581.

At 583, the process 580 determines whether the automation enable switch 515 is “ON” or “OFF”. If the automation enable switch 515 is “ON”, the process 580 proceeds to 584. If the automation enable switch 515 is “OFF”, the process 580 proceeds to 591.

At 584, the process 580 determines whether the wall switch 510 has been turned “ON” or “OFF”. If the wall switch 510 is turned “ON”, the process 580 proceeds to 585. If the wall switch 510 is turned “OFF”, the process 580 proceeds to 586.

At 585, the target device 550 is turned “ON” and the process 580 returns to 584. At 586, the process 580 waits a user defined delay period and then proceeds to 587.

At 587, the process 580 determines whether the wall. switch 510 has been turned “ON” or “OFF”. If the wall switch 510 is turned “ON”, the process 580 proceeds to 588. If the wall switch 510 is turned “OFF”, the process 580 returns to 581.

At 588, the process 580 determines whether the delay period is less than a time period T. The time period T is the time Point B in FIG. 5A is able to sustain a predefined voltage when the switch 510 is “OFF” and the switch 515 is in the 1 position. In some embodiments, the time T can be in a range of ˜milliseconds to ˜seconds. If the delay period is less than the time period T, the process 580 proceeds to 589. If the delay period is not less than the time period T, the process 580 returns to 585. At 589, automation of the independent wireless remote device 500 and the target device 550 is enabled and the process 580 proceeds to 590.

At 590, the process 580 determines whether the wall switch 510 has been turned “ON” or “OFF”. If the wall switch 510 is turned “ON”, the process 580 proceeds back to 589. If the wall switch 510 is turned “OFF”, the process 580 RETURNS to 581.

Back to 583, if the automation enable switch 511 is determined to be “OFF”, the process 580 proceeds to 591. At 591, the target device 550 is turned “ON” and the process 580 proceeds to 592. At 592, the process 580 determines whether the wall switch 510 has been turned “ON” or “OFF”. If the wall switch 510 is turned “ON”, the process 580 proceeds back to 591. If the wall switch 510 is turned “OFF”, the process 580 proceeds back to 581.

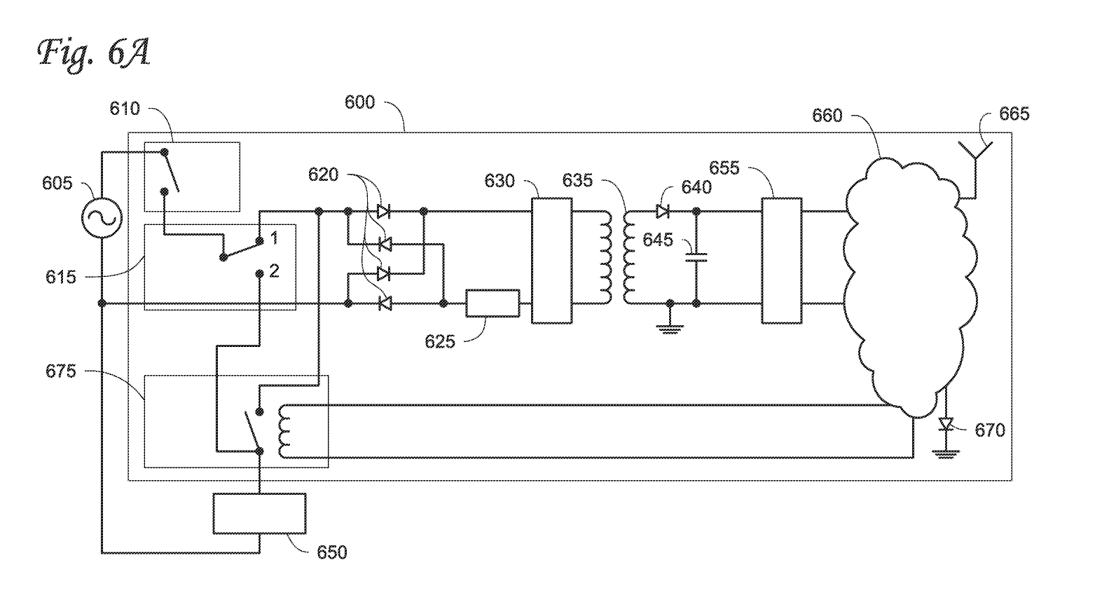

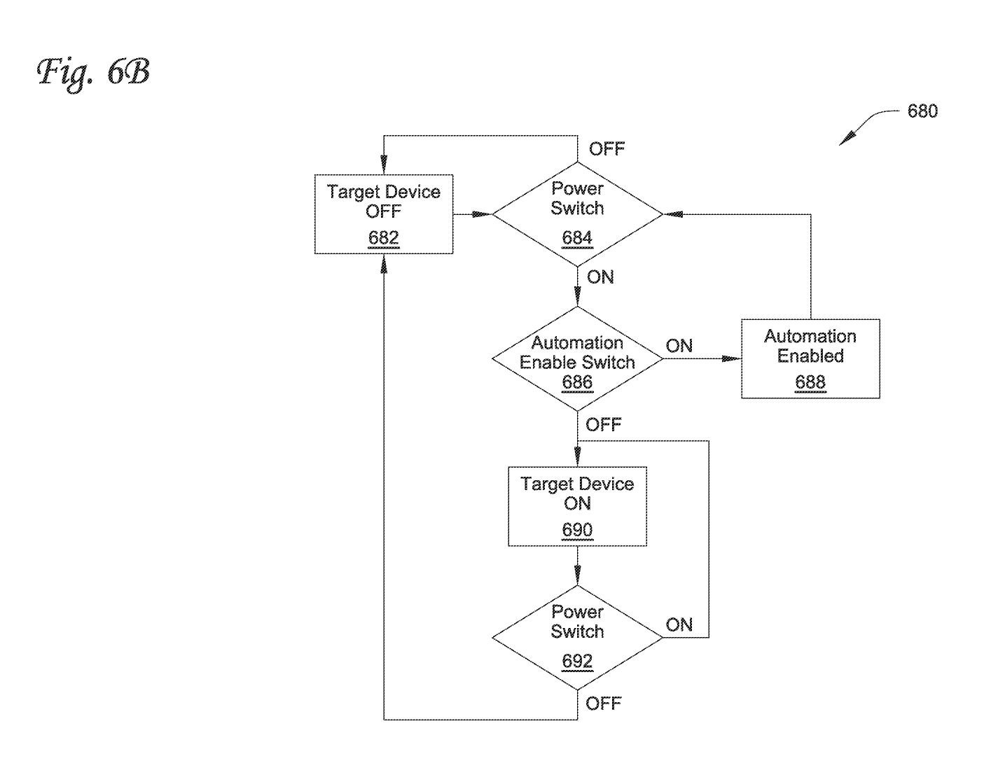

FIG. 6A illustrates a circuit diagram of an independent wireless remote device 600 for controlling a target device 650 where the independent wireless remote device 600 is powered by a power source 605 via a power outlet. In this embodiment, a power switch 610 along with an automation switch 615 is built into the independent wireless remote device 600. While the target device 650 is external to the independent wireless remote device 600, in other embodiments, the target device 650 is integrated within the independent wireless remote device 600. In this embodiment, the power source 605 is an AC power source.

The independent wireless remote device 600 also includes a set of diodes 620 connected to a pulse width modulation circuit (PWM) 625 and a filter/transient protection circuit 630. The PWM 625 is also connected to the filter/transient protection circuit 630. The filter/transient protection circuit 630 is connected to a transformer 635. The transformer 635 is connected to a diode 640. The diode 640 is connected to a capacitor 645 and a DC power supply circuit 655. The DC power supply circuit 655 is connected to an analog and digital processor circuit 660. The analog and digital circuit 660 includes, but is not limited to, a CPU, a primary wireless transceiver unit, a memory unit, and a target device unit (such as the CPU 210, the primary wireless transceiver unit 220, the memory unit 230, and the target device unit 240 shown in FIG. 2). The analog and digital processor circuit 660 is connected to an antenna 665 and to an LED 670. In this embodiment, the target device 650 is driven by an AC power signal, and thus the independent wireless remote device 600 also includes a relay switch 675. In some embodiments, when the target device 650 is driven by a DC power signal, the independent wireless remote device 600 does not include relay switch 675. In these embodiments, the target device 650 is driven by a DC power signal via the DC power supply circuit 655 or the analog and digital processor circuit 660.

Also, in some embodiments the relay switch 675 and relay control signal/device sent to the relay switch 675 is not limited to an actual relay, but can be any type of control signal that provides the appropriate signal to power and/or control the target device 650. The rectifier diodes 620, the pulse width modulator 625, the transformer 635, the reverse current protection diode 640, and the bulk capacitor 645 are provided for converting an AC voltage into a DC voltage. The filter and transient protection circuit 630 is provided to prevent over voltage or over current transients from damaging the independent wireless remote device 600. The LED 670 is used to indicate whether automation of the independent wireless remote device 600 and the target device 650 is enabled or disabled.

The position of the automation switch 615 determines whether the independent wireless remote device 600 and the target device 650 are controlled via a wireless automation network (such as the wireless automation network 100 shown in FIG. 1). In this embodiment, when the automation switch 615 is set to position 1 (e.g. the on setting), the LED 670 is turned on indicating that wireless automation of the independent wireless remote device 600 and the target device 650 is enabled. When the switch 615 is set to position 2, the LED 670 is turned of indicating that wireless automation is disabled, and the relay switch 675 is not functional.

FIG. 6B illustrates a process 680 for enabling/disabling automation of the independent wireless remote device 600 and the target device 650 (shown in FIG. 6A). The process 680 begins at 682 where the target device 650 is “OFF”. The process 680 then proceeds to 684.

At 684, the process 680 determines whether the power switch 610 is “ON” or “OFF”. If the power switch 610 is “ON”, the process 680 proceeds to 686. If the power switch 610 is “OFF”, the process 680 returns to 682.

At 686, the process 680 determines whether the automation enable switch 615 is “ON” or “OFF”. If the automation enable switch 615 is “ON”, the process 680 proceeds to 688. If the automation enable switch 615 is “OFF”, the process 680 proceeds to 690.

At 688, automation of the independent wireless remote device 600 and the target device 650 is enabled and the process 680 proceeds back to 684.

At 690, the process 680 turns the target device 650 “ON” and the process proceeds to 692. At 692, the process 680 determines whether the power switch 610 has been turned “ON” or “OFF”. If the power switch 610 is turned “ON”, the process 680 proceeds back to 690. If the power switch 610 is turned “OFF”, the process 680 proceeds back to 682.

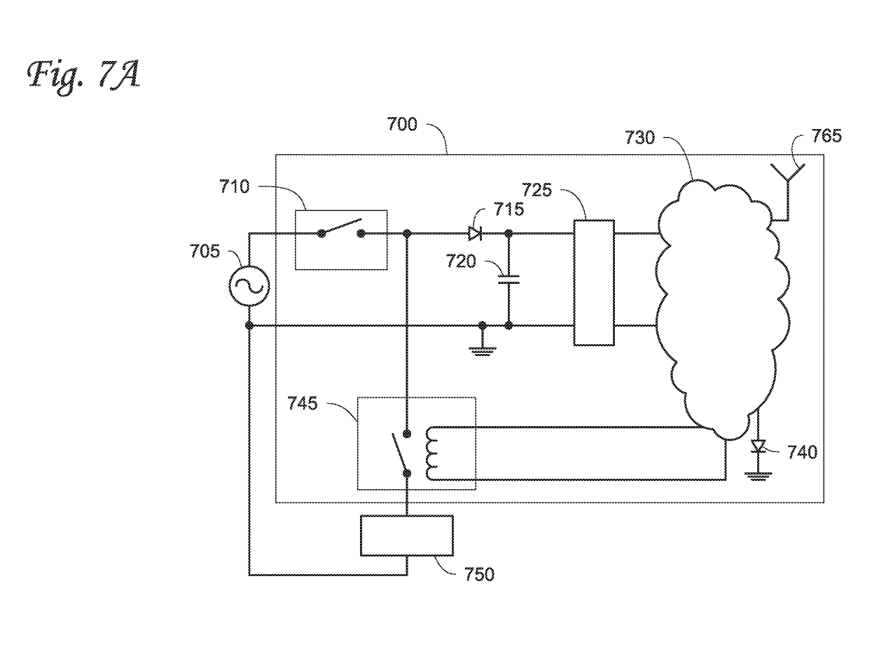

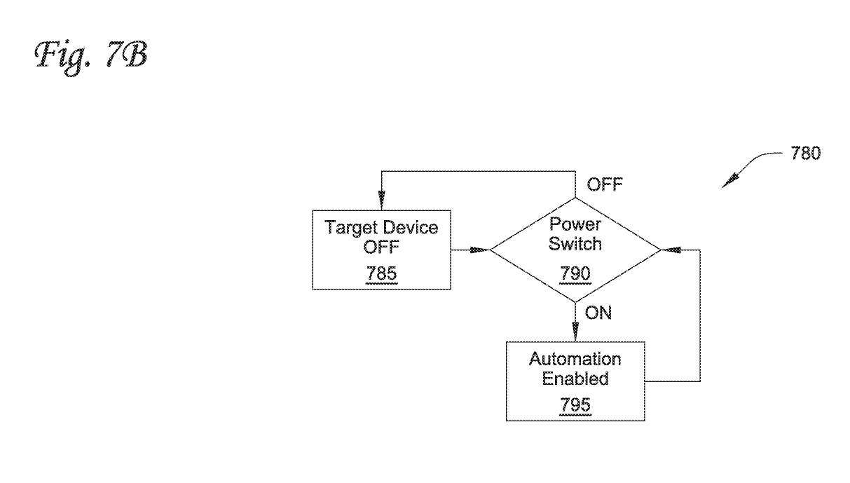

FIG. 7A illustrates a circuit diagram of a independent wireless remote device 700 for controlling a target device 750 where the independent wireless remote device 700 is powered by a regenerative power source 705 (e.g., a rechargeable battery, a solar power cell, etc.) installed in the independent wireless remote device 700. In this embodiment, the regenerative power source 705 is a DC power source. In this embodiment, a power switch 710 is built into the independent wireless remote device 700. While the target device 750 is external to the independent wireless remote device 700, in other embodiments, the target device 750 is integrated within the independent wireless remote device 700.

The power switch 710 is connected to a relay switch 745 and a diode 715. The diode 715 is connected to a capacitor 720 and a DC power supply circuit 725. The DC power supply circuit 725 is connected to the analog and digital circuit 730. The analog and digital circuit 730 includes, but is not limited to, a CPU, a primary wireless transceiver unit, a memory unit, and a target device unit (such as the CPU 210, the primary wireless transceiver unit 220, the memory unit 230, and the target device unit 240 shown in FIG. 2). In this embodiment, the target device 750 is driven by a DC power signal equivalent to the VDC Source 705, and thus is connected to the VDC Source 705 via the relay switch 745 and the power switch 710. In other embodiments, the target device 750 is driven by the DC power supply circuit 725, the analog and digital circuit 730, or other circuits capable of driving the target device 750 directly.

Also, in some embodiments the relay switch 745 and relay control signal sent to the switch 745 is not limited to an actual relay, but can be any type of control signal/device that provides the appropriate signal to power and/or control the target device 750. The reverse current protection diode 715 and the bulk capacitor 720 are provided for supplying the DC power supply circuit 725 with an appropriate voltage and current polarity. The DC power supply circuit 725 is to supply the analog and digital circuits 730 with a stable voltage, where the stable voltage may be of a reduced value compared to the VDC Source 705. The LED 740 is used to indicate power to the independent wireless remote device 700.

FIG. 7B illustrates a process 780 for enabling/disabling automation of the independent wireless remote device 700 and the target device 750 (shown in FIG. 7A). The process 780 begins at 785 where the target device 750 is “OFF”. The process 780 then proceeds to 790.

At 790, the process 780 determines whether the power switch 710 is “ON” or “OFF”. If the power switch 710 is “ON”, the process 780 proceeds to 795. If the power switch 710 is “OFF”, the process 780 returns to 785. At 795, automation of the independent wireless remote device 700 and the target device 750 is enabled and the process 780 returns to 790.

The inventive concepts disclosed herein may be embodied in other forms without departing from the spirit or novel characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A monitoring and automating system comprising:
a mobile device;
one or more independent wireless remote devices, each of the one or more remote devices including a central processing unit, a target device unit, a memory unit, and a wireless transceiver unit configured to communicate with the mobile device,
wherein the central processing unit of each of the one or more independent wireless remote devices is configured to use data received from the wireless transceiver unit and data stored in the memory unit to control the target device unit,
wherein the central processing unit is configured to control operation of the target device unit based on a distance between the mobile device and the independent wireless remote device.

2. The monitoring and automating system of claim 1, wherein one of the independent wireless remote device and the mobile device is configured to calculate the distance between the mobile device and the independent wireless remote device based on a first signal strength between the mobile device and the independent wireless remote device using a first wireless protocol signal and is configured to calculate the distance between the mobile device and the remote device based on a second signal strength between the mobile device and the remote device using a second wireless protocol signal.

3. The monitoring and automating system of claim 2, wherein one of the independent wireless remote device and the mobile device is configured to interchange using the first wireless protocol signal and the second wireless protocol signal to calculate the distance between the mobile device and the independent wireless remote device.

4. The monitoring and automating system of claim 2, wherein the first wireless protocol signal is one of a WiFi signal, a Bluetooth signal, a ZigBee signal or a global positioning system signal, and the second wireless protocol signal is a different one of a WiFi signal, a Bluetooth signal, a ZigBee signal or a global positioning system signal.

5. The monitoring and automating system of claim 1, wherein the target device unit is one of an intermediate automation device, an intermediate monitoring device or an independent end product.

6. The monitoring and automating system of claim 5, wherein the intermediate automation device is one of a motor, a relay, a power strip, a light bulb adapter configured to house a light bulb, a wireless bridge.

7. The monitoring and automating system of claim 5, wherein the intermediate monitoring device is one of a temperature sensor, a humidity sensor, a fire/smoke sensor, a water sensor, an image sensor, or a motion sensor.

8. The monitoring and automating system of claim 5, wherein the independent e product is one of a set of blinds or shades, a car security system, light bulb adapter configured to house a light bulb, a media device, an appliance, or a camera.

9. The monitoring and automating system of claim 1, wherein the central processing unit is configured to control operation of the target device unit based on instructions received by the mobile device when the mobile device is within a first distance from the independent wireless remote device.

10. An independent wireless remote device comprising:
a central processing unit;
a target device unit connected directly or indirectly to the central processing unit;
a memory unit connected to the central processing unit; and
a wireless transceiver unit connected to the central processing unit and configured to communicate with a mobile device,
wherein the central processing unit is configured to use data received from the mobile device via the wireless transceiver unit and data stored in the memory unit to control operation of the target device unit, and
wherein the central processing unit is configured to control operation of the target device unit based on a distance between the independent wireless remote device and the mobile device.

11. The independent wireless remote device of claim 10, wherein the central processing unit is configured to calculate the distance between the wireless transceiver unit and a mobile device based on a first signal strength between the wireless transceiver unit and the mobile device using a first wireless protocol signal and is configured to calculate the distance between the wireless transceiver unit and the mobile device based on a second signal strength between the wireless transceiver unit and the mobile device using a second wireless protocol signal.

12. The remote device of claim 10, wherein the wireless transceiver unit is configured to interchange using the first wireless protocol signal and the second wireless protocol signal to calculate the distance between the wireless transceiver unit and the mobile device.

13. The independent wireless remote device of claim 12, wherein the first wireless protocol signal is one of a WiFi signal, a Bluetooth signal, a ZigBee signal or a global positioning system signal, and the second wireless protocol signal is a different one of a WiFi signal, a Bluetooth signal, a ZigBee signal or a global positioning system signal.

14. The independent wireless remote device of claim 10, wherein the target device unit is one of an intermediate automation device, an intermediate monitoring device or an independent end product.

15. The independent wireless remote device of claim 14, wherein the intermediate automation device is one of a motor, a relay, a power strip or a wireless bridge.

16. The independent wireless remote device of claim 14, wherein the intermediate monitoring device is one of a temperature sensor, humidity sensor, a fire/smoke detection sensor, a water sensor or a motion sensor.

17. The independent wireless remote device of claim 14, wherein the independent end product is one of a set of blinds or shades, a car security system, light bulb adapter configured to house a light bulb, a media device, an appliance, or a camera.

18. The remote device of claim 10, wherein the central processing unit is configured to control operation of the target device unit based on instructions received by the mobile device when the mobile device is within a first distance from the remote device.

19. The independent wireless remote device of claim 10, further comprising an automation switch unit configured to instruct the central processing unit to control operation of the target device unit based on a distance between the wireless transceiver unit and the mobile device when the automation switch unit is enabled, and configured to instruct the central processing unit to not control operation of the target device unit based a distance between the wireless transceiver unit and the mobile device when the automation switch unit is disabled.

20. A method for operating an independent wireless remote device within a monitoring and automating system, the independent wireless remote device integrated with a central processing unit, a wireless transceiver unit and a target device unit, the method comprising:
determining a distance between the independent wireless remote device and a mobile device based on a signal strength between the wireless transceiver unit and the mobile device using a first wireless protocol signal;
controlling, via the central processing unit, operation of the target device unit based on distance settings, time settings, environmental settings, or user settings when the distance between the remote device and the mobile device is less within range of the wireless protocol; and
controlling, via the central processing unit, operation of the target device unit based on user settings, time settings or environment settings when the distance between the remote device and the mobile device is greater than the first distance.

21. A mobile device comprising:
a GPS component configured to determine a location of an independent wireless remote devices;
a wireless communication component configured to communicate with the independent wireless remote device; and
a control component configured to send control instructions to the independent wireless remote device and configured to calculate a distance between the independent wireless remote device and the mobile device;
wherein the wireless communication component and the GPS component are each configured to determine a distance between the mobile device and the independent wireless remote device, and
wherein the control component is configured to control operation of the independent wireless remote device based on a distance between the mobile device and the independent wireless remote device.
